(19) United States
(12) Patent Application Publication
(10) Pub. No.: US 2004/0168081 A1
(43) Pub. Date: Aug. 26, 2004

(54) Apparatus and method simplifying an encrypted network

(75) Inventors: Corey M. Ladas, Bellevue, WA (US); Matthew D. Childerston, Redmond, WA (US); Neel R.S. Malik, Seattle, WA (US)

Correspondence Address: MICROSOFT CORPORATION, LAW OFFICES OF RONALD M. ANDERSON, 600 108TH AVENUE N.E., SUITE 507, BELLEVUE, WA, 98004, US

(73) Assignee: Microsoft Corporation, Redmond, WA

(21) Appl. No.: 10/370,192

(22) Filed: Feb. 20, 2003

(51) Int. Cl. H04L 9/00

(52) U.S. Cl. 713/201

(57) ABSTRACT

A computing device is enabled to join a secure network with minimal user interaction. Either a user of the computing device, or a person authorized to control access to the secure network can initiate a bind step to enable the computing device to join the network. A temporary alternate network is then created between an access point of the network and the computing device network interface card (NIC). Network credentials (optionally, encrypted) are then transmitted to the computing device NIC. These parameters are decrypted by the computing device NIC (if they were encrypted) and used by it to join the secure network. Optionally, a secret can be encrypted, transmitted to the access point, and verified prior to the access point providing these parameters to the computing device. The secret ensures that a third party is not improperly authorized to access the secure network.

### FIELD OF THE INVENTION

This invention generally relates to joining a first computing device to a network, and more specifically, to enabling a decision by an authorized user input through a second computing device to facilitate automatically joining the first computing device to an encrypted secure network to which the user controls access, with minimal input by the user.

### BACKGROUND OF THE INVENTION

When wireless networks are used in homes and in small businesses for coupling computers and other types of computing devices in communication with each other and for accessing the Internet, they typically do not make use of the encryption capabilities that are provided with the wireless network interface cards (NICs) and access point(s) being used. Most users find it too difficult to establish a secure encrypted network for home or small business use, since the tasks involved with setting up a secure encrypted wireless network are often beyond the skill levels of such users. Even if a secure encrypted wireless network is initially created, problems often occur when a user wants to add a new computer or other device to the secure encrypted wireless network. Each time that a new computer or other type of computing device is added to a secure encrypted wireless network, the user must open the user interface for the wireless NIC card on the new device, enter the correct network name and other parameters currently employed on the network, and determine and enter the correct 26 character network key to join the new computing device to the secure encrypted wireless network. If an incorrect parameter is entered, such as an incorrect wire equivalent privacy (WEP) key, the computing device will not be successfully joined to the secure wireless network. After experiencing the frustration of managing a conventional secure encrypted wireless network, most users simply decide to run their wireless network in unencrypted mode, without any encryption security. Current operating systems such as Microsoft Corporation's WINDOWS XP™ running on a computer that is brought into the vicinity of a previously unseen existing wireless network will automatically detect the wireless network and can join the computer to the network without the need to provide configuration parameters, but only if the network is not encrypted. While joining an unencrypted wireless network in this manner is very convenient, it leaves the network open so that an unauthorized party having a computer with a wireless access interface device can readily join the wireless network, without permission. As a result, private files of users of the network may be accessible to unauthorized parties who are within range of the wireless network.

Clearly, it is preferable to operate wireless networks in a secure encrypted mode to avoid unauthorized access by others. However, most manufacturers of wireless network components distribute their products with the default mode set for unencrypted operation. To make it easier for users to join an encrypted network, some prior art wireless NICs or other wireless network interface devices permit a user to enter a phrase, which is then hashed with a predefined algorithm to determine the encryption key for a network. So long as all of the wireless network components on the wireless network are from the same manufacturer, this approach will provide the correct WEP key if the user correctly recalls and enters the phrase that was previously chosen. However, use of a phrase to determine the network key also makes it easier for a hacker to gain access to a secure encrypted wireless network. In addition, different hashing algorithms are used by different manufacturers of wireless network components, so that entry of the correct phrase on a different manufacturer's wireless network product may likely not result in the correct network key being determined by the device.

Recently, the Wi-Fi Alliance has started development of a Wireless Protected Access (WPA) specification for an 802.11i Standard that will be used for both data encryption and network access control. For encryption, WPA will employ the Temporal Key Integrity Protocol (TKIP), which uses the same algorithm as WEP, but constructs network keys differently and provides improvements in network security. For access control, WPA will use the IEEE 802.1× protocol, a recently completed standard for controlling entry to both wired and wireless LANs. In the approach to be employed for WPA, each user will have their own encryption key, and that key can be set to change periodically. In corporate environments, authentication can be handled by an authentication server, so that more users can be handled than could using the WEP key. For smaller or home networks, a “pre-shared key” mode can be used that does not require an authentication server and enables a user to log in to a network if the pre-shared key on the user's system matches the one on the wireless access point.

While advances have been made in initially setting up a secure encrypted wireless network (which is the default mode for wireless components produced by Microsoft Corporation) and in improving the security of an encrypted network, the problems related to joining a new computing device to a secure encrypted wireless network still remain. Accordingly, it is evident that a simpler approach is required to join a new computing device to a wireless network that avoids the need for a user to recall or enter a WEP or WPA key and which requires only a decision by the person authorized to control access to the wireless network regarding whether to allow the new computing device to join the secure network. It would also be desirable to authorize a new device to join a network for a predefined or limited time. Communications should also be secure between the new computing device and the access point used to control access to the secure wireless network, when providing the new computing device with the necessary parameters to join the secure wireless network, and steps should preferably be taken to preclude a third party from intercepting the communications and pretending to be the user of the new computing device that is being enabled to join the secure wireless network. Clearly, the approach is not limited to a secure wireless network, but would also be usable with other types of secure networks.

### SUMMARY OF THE INVENTION

The present invention is employed for automating the process of joining a computing device to an existing secure network. Instead of requiring that the person controlling access to this network manually provide an identifier and a security key, a relatively simple automated procedure is employed that requires very little input for the user of the computing device or the person granting permission to join the network. Either the user of the computing device desiring to join the secure network or the person authorized to permit the computing device to join the network can initiate the automated process. A bind option is activated on the computing device and on an access point used on the secure network. In response to the bind option being activated, a secure encrypted communication link is automatically produced between the computing device and the access point. Assuming that permission is granted for the computing device to join the network, a secure encrypted message is preferably transmitted from the access point to the computer device. The encrypted message conveys credentials that are required by the computing device to join the secure network. The encrypted message is decrypted at the computing device to recover the credentials required to join the secure network, such as the SSID and WEP key, or the WPA key. Using the credentials, the computing device then joins the secure network.

The step of automatically producing the encrypted wireless network preferably comprises the step of producing an encryption key for use in communicating over the encrypted communication link. For example, the encryption key can be a private key from a private/public key set or can be produced using a Diffie-Hellman key exchange.

Optionally, a secret can be entered on the computing device by the user. This secret is also known by the person authorized to join the computing device to the secure network. The secret is included in a secure encrypted message that is transmitted to the access point, where the encrypted message is decrypted to recover the secret. The person authorized to join the computing device to the network, who is at the access point, can thus determine if the secret that is known was actually recovered from the encrypted message. If not, it is possible that a third party intermediary may have intercepted the encrypted message, and by detecting the interception and attempted ruse, the third party can be prevented from joining the secure network.

Unless the secure network is using a protocol that permits parallel communication links over the network, normal communications over the secure network will be interrupted while joining the computing device to the secure network.

Preferably, the step of enabling activation of the bind option will include displaying a graphic user interface option to bind the computing device to the secure network.

Another aspect of the present invention is directed to a system for enabling joining a secure network. The system includes a memory in which machine instructions are stored, and a network communications interface. A processor is coupled to the network communications interface and the memory and executes the machine instructions, which cause the processor to carry out functions that are generally consistent with the functions implemented by the computing device in the above described method. Similarly, a system that enables a computing device to join a secure network in accord with the present invention includes a memory, a network communications interface, and a processor that executes machine instructions, causing the processor to carry out functions generally corresponding to the steps of the method executed by the access point as described in regard to the above method.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram of an exemplary computing environment suitable for implementing the present invention;

FIG. 2 is a block diagram of an exemplary secure wireless network with which the present invention is usable;

FIG. 3 is an isometric view of a network access device that implements the present invention and is used to join a computing device to a secure wireless network;

FIG. 4 is an isometric view of an access point that implements the present invention;

FIG. 5 is a diagram generally illustrating the steps that are carried out in response to a bind “button” being activated on a computing device (or a NIC of a computing device), to join a secure wireless network;

FIG. 6 is a diagram generally illustrating the steps that are carried out in response to a bind “button” being activated on an access point, to initiate joining a computing device to a secure wireless network;

FIG. 7 is a more detailed diagram illustrating the steps carried out in accord with the present invention to join a computing device to a secure wireless network;

FIG. 8A is an exemplary graphic user interface for an access point that includes a bind control for initiating joining a computing device to a secure wireless network; and

FIG. 8B is an exemplary graphic user interface for a NIC (or other device for communicating with the wireless network) that includes a bind control for initiating joining a computing device coupled to a secure wireless network.

### DESCRIPTION OF THE PREFERRED EMBODIMENT

Exemplary Operating Environment

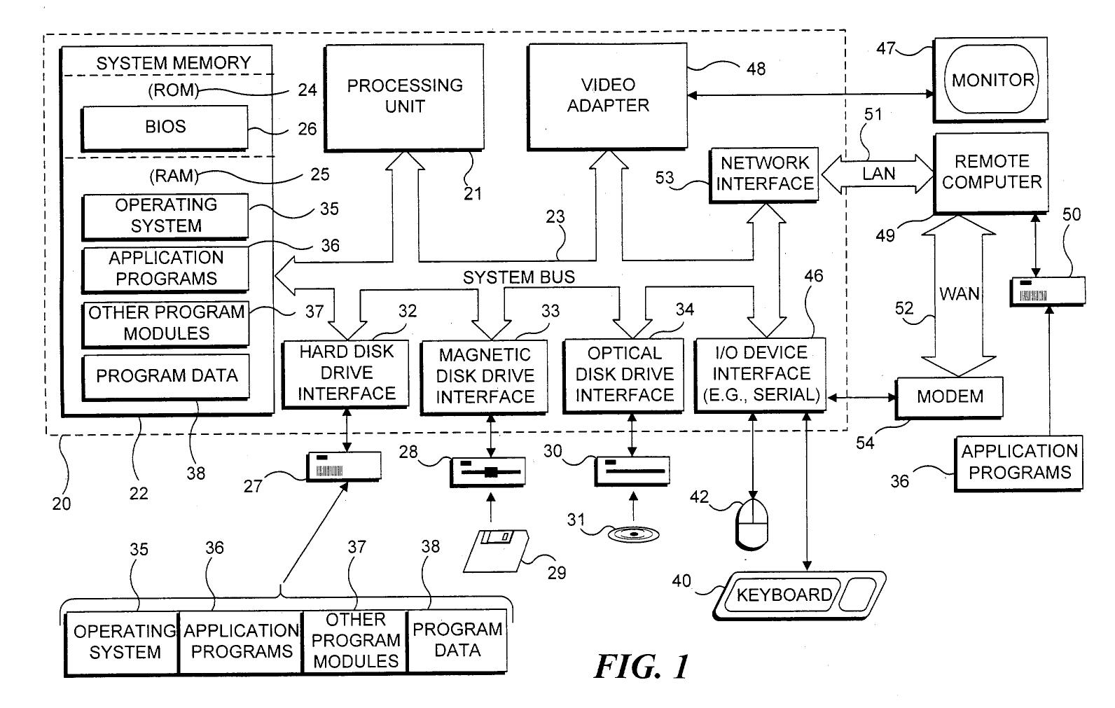

FIG. 1 and the following discussion are intended to provide a brief, general description of a suitable computing environment implementing the present invention. Although not required, a portion of the present invention will be described in the general context of computer executable instructions, such as program modules that are executed by a wireless access device and/or a computing device, such as a personal computer (PC), in association with a network interface card or equivalent Generally, program modules include routines, programs, objects, components, data structures, etc. that perform particular tasks or implement particular abstract data types. In addition to joining a PC to a secure wireless network, those skilled in the art will appreciate that this invention may be employed to join other computing devices to a secure wireless network, including game consoles, TV set-top boxes, multiprocessor systems, network personal computers, minicomputers, mainframe computers, industrial control equipment, automotive equipment, aerospace equipment, peripheral devices, hand held devices, pocket personal computing devices, digital cell phones adapted to connect to a network, and other microprocessor-based or programmable consumer electronic devices. The invention can also be practiced in distributed computing environments where tasks are performed by remote processing devices that are linked through a communications network. In a distributed computing environment, program modules may be located in both local and remote memory storage devices.

With reference to FIG. 1, an exemplary computing environment for implementing the present invention includes a general purpose computing device in the form of a conventional PC 20. PC 20 is provided with a processing unit 21, a system memory 22, and a system bus 23. The system bus couples various system components, including the system memory, to processing unit 21 and may be any of several types of bus structures, including a memory bus or memory controller, a peripheral bus, and a local bus using any of a variety of bus architectures. The system memory includes read-only memory (ROM) 24 and random access memory (RAM) 25. A basic input/output (BIOS) system 26, containing the basic routines that help to transfer information between elements within the PC 20, such as during start up, is stored in ROM 24.

The PC 20 further includes a hard disk drive 27 for reading from and writing to a hard disk (not shown), a magnetic disk drive 28 for reading from or writing to a removable magnetic disk 29, and an optical disc drive 30 for reading from or writing to a removable optical disc 31, such as a compact disk-read only memory (CD-ROM) or other optical media. Hard disk drive 27, magnetic disk drive 28, and optical disc drive 30 are connected to system bus 23 by a hard disk drive interface 32, a magnetic disk drive interface 33, and an optical disc drive interface 34, respectively. The drives and their associated computer-readable media provide nonvolatile storage of computer-readable machine instructions, data structures, program modules, and other data for PC 20. Although the exemplary environment described herein employs a hard disk, a removable magnetic disk 29, and a removable optical disc 31, it will be appreciated by those skilled in the art that other types of computer-readable media, which can store data that are accessible by a computer, such as magnetic cassettes, flash memory cards, digital video discs, Bernoulli cartridges, random access memories (RAMs), ROMs, and the like, may also be used in the exemplary operating environment. A number of program modules may be stored on the hard disk, magnetic disk 29, optical disc 31, ROM 24 or RAM 25, including an operating system 35 (optionally including one or more device drivers), one or more application programs 36 (such as a setup program), other program modules 37, and program data 38.

A user may enter commands and information into PC 20 through input devices such as a keyboard 40 and a pointing device 42. Other input devices (not shown) may include a microphone, joystick, game pad, satellite dish, scanner, digital camera, or the like. These and other input devices are often connected to processing unit 21 through an input/output (I/O) device interface 46 that is coupled to the system bus. Output devices, such as a printer (not shown), may also be connected to processing unit 21 through I/O device interface 46 that is coupled to the system bus. The term I/O device interface is intended to encompass each interface specifically used for a serial port, a parallel port, a game port, a keyboard port, a PS/2 port, a USB port and/or other I/O ports. Similarly, a monitor 47 or other type of display device is also connected to system bus 23 via an appropriate interface, such as a video adapter 48, and is usable to display a graphical user interface, application program interfaces, Web pages, and/or other information. In addition to the monitor, PCs are often coupled to other peripheral output devices (not shown), such as speakers (through a sound card or other audio interface—not shown).

PC 20 preferably operates in a networked environment using logical connections to one or more remote other computing devices, such as other local area network (LAN) computers or computing devices (not shown in this Figure) coupled together in a secure wireless network, and possibly other computing devices that are connected by a wired network, such as a remote computer 50. The other LAN computers and remote computer 50 will typically each be another PC, and/or a server and will typically be generally configured much like PC 20. Other types of computing devices that might be coupled in a secure wireless network will at least include a processor and memory for storing machine instructions. Logical connections to other computing devices can further include a wide area network (WAN) 52, such as the Internet, which preferably uses a well known WAN protocol such as TCP/IP. Such networking environments are common in offices, enterprise-wide computer networks, intranets, and the Internet.

When used in a LAN networking environment, PC 20 is connected to LAN segment 51 through a network interface or adapter 53, which can alternatively be a wireless NIC. When used in a WAN networking environment, PC 20 typically uses a modem 54 or other means for establishing communications over WAN 52. Modem 54 may be internal or external to PC 20, but for exemplary purposes, will be discussed below primarily as a broadband modem, such as an xDSL modem, cable modem, or other high speed modem. PC 20 is often externally coupled to modem 54 via LAN segment 51, a gateway 55, and a WAN segment 56. WAN segment 56 will normally comprise a standard LAN segment, but is preferably the only LAN segment that accesses WAN 52. It will be appreciated that the network connections shown are exemplary and other means for linking the computers in communication may be used. In many cases, PC 20 will be a laptop or other type of portable computing device, and network interface 53 will comprise a Personal Computer Memory Card International Association (PCMCIA) NIC card that includes the circuitry for wireless communication with an access point. It should be noted that PC 20 may instead be coupled to an access point (not shown) via network interface 53 (typically an Ethernet port) and will be used for displaying a user interface dialog that facilitates enabling another computing device to join the secure wireless network administered through PC 20.

Exemplary Secure Wireless Network

Although the present invention is not limited to use with a wireless network, it will likely initially be used in connection with joining a computing device to such a network. However, it must be emphasized that the present invention can be employed to join a computing device to almost any type of secure network, and no implied limitation is intended by the following discussion relating to its use with a wireless network.

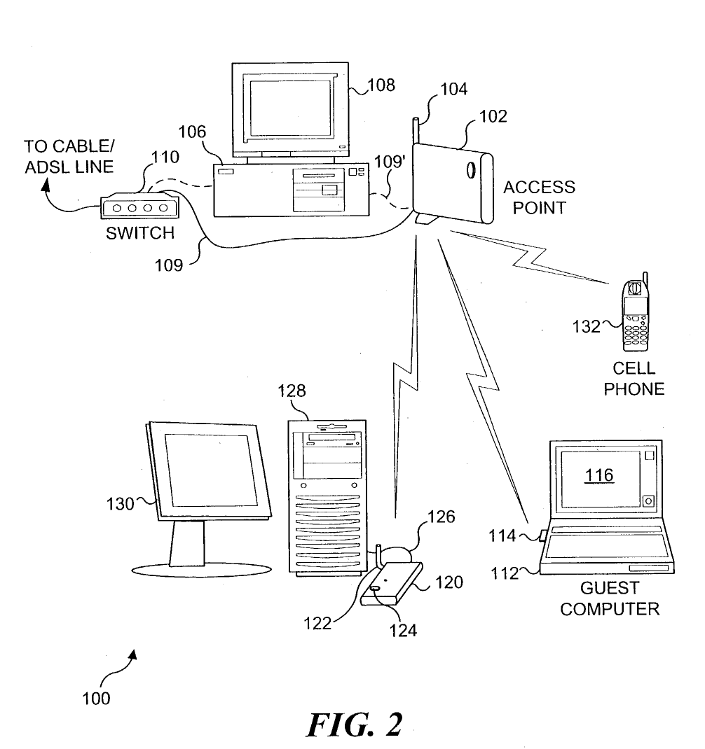

An exemplary secure wireless network 100 is illustrated in FIG. 2. In this relatively simple exemplary wireless network, an access point 102 is preferably coupled to a combination switch and gateway 110 through an Ethernet cable 109. Access point 102 includes an antenna 104 for transmitting and receiving wireless signals used to communicate over secure wireless network 100. For example, access point 102 may communicate using radio frequency signals that conform to one of the Institute of Electrical and Electronic Engineers (IEEE) Specifications 802.11b, 802.11a, 8021g, or some other suitable wireless network specification. A PC 106 is coupled to another Ethernet port on gateway and switch 110, but may instead be coupled through a wireless connection such as a wireless communication card that is installed on a bus within PC 106. A display 108 is provided for displaying graphics and text to a user of PC 106.

It is also contemplated that access point 102 may be connected to another Ethernet port (not shown) on PC 106 through Ethernet cable 109′, instead of being coupled to gateway and switch 110 directly. In either case, access point 102 can be readily administered by a user of PC 106 (or by an authorized user through any of the other PCs using the secure wireless network), using either an administrative program or a Web browser interface that displays a hypertext markup language (HTML) graphic user interface to access point 102. It is generally considered preferable to administer an access point using a computer having a direct wire connection to the access point, since changes made to a wireless network through the administrative interface may then interfere with the communication between computer and the access point. Loss of communication between the computer and the access point due to changes in the wireless network made within the administrative interface is unlikely if they are directly connected in communication by an Ethernet cable. Gateway and switch 110 is typically also coupled to either a cable modem or ADSL modem, and secure wireless network 100 will thus have broadband access to the Internet (or access to some other form of public or private WAN).

Although a secure wireless network may include multiple access points, the simple secure wireless network shown in FIG. 2 has only access point 102. The access point provides secure wireless communications with one or more other computing devices in the network. For example, a wireless network interface device 120, which includes an external antenna 122, communicates with access point 102 over the secure wireless network using a WEP key that may optionally be changed periodically. Wireless interface device 120 includes an optional bind button 124, the function of which is explained below. A USB (or Ethernet) cable 126 couples the wireless network interface device to a PC 128 to enable the PC to communicate over the secure wireless network with PC 106 (and other computing devices that have joined the network), through access point 102. PC 128 is also coupled to a display 130. In addition, PC 128 has broadband access to the Internet (or other WAN) to which gateway and switch 110 is connected.

While it is likely that the present invention will initially typically be used for joining a computing device such as a PC to a secure wireless network, it is also contemplated that it could be used for joining other types of computing devices to a secure wireless network. For example, as shown in FIG. 2, a cell phone 132 can also be joined to the secure wireless network. Also, it will be apparent that cell phone 132 may be coupled to a secure network using a different protocol, such as Bluetooth. Still other types of computing devices such as personal digital assistants (PDAs), set top boxes, electronic games, entertainment equipment, and various appliances might also be coupled to a secure network in accordance with present invention.

The present invention facilitates joining a computing device that is not currently connected to secure wireless network 100 so that it to can engage in secure wireless communications via the secure wireless network. In the example shown in FIG. 2, a guest computer 112, which is shown as a laptop or portable PC with a display 116, is enabled by the present invention to join secure wireless network 100 with a minimum of user interaction. The term “guest computer” in reference to PC 112 is not intended to be limiting since PC 112 may be a new computer that is being added to the secure wireless network on a generally permanent basis. However, the term is used in this example, since it is not uncommon for a friend having a portable PC to visit a home in which a secure wireless network 100 is operational and desire to join the PC to the wireless network to participate in the broadband Internet communications and/or to communicate with other computers or computing devices that are coupled to the wireless network. In a business environment, PC 112 may instead be viewed as another computing device that is being added to the business' secure network. As explained below, the present invention automates joining PC 112 to the wireless network, and a user of PC 112 is not required to know a SSID or WEP key (or WPA key) used by the secure network in order for PC 112 to join the network. The user of PC 112 and a person authorized to determine whether PC 112 can join secure wireless network 100 (which may be the same person) are not required to remember either the SSID or WEP or WPA key being used on the wireless network. Details of the steps involved in automating the joining of PC 112 to the secure network are explained below.

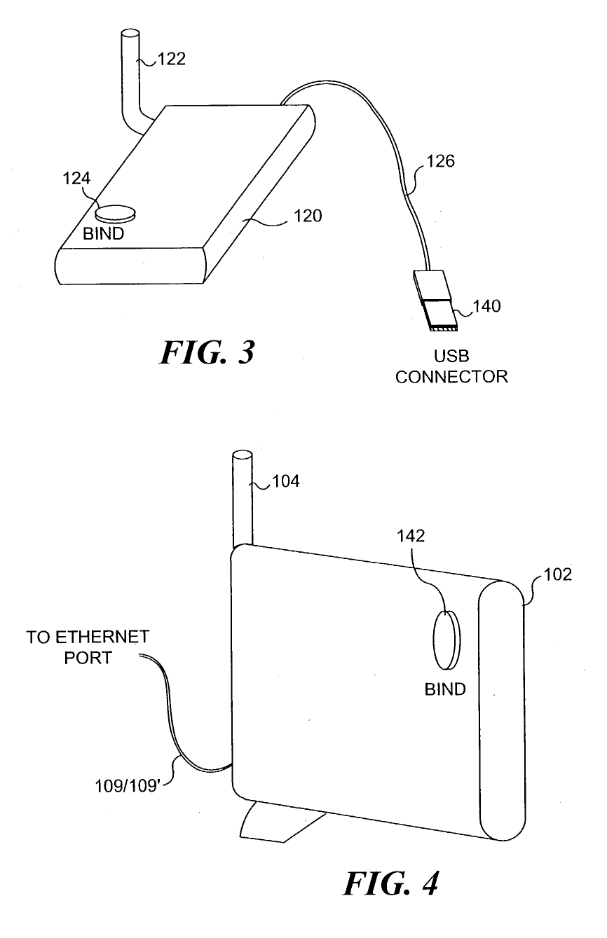

FIG. 3 shows further details of wireless network interface device 120, which is connected to a USB connector 140 via USB cable 126. Alternatively, USB cable 126 can be replaced with an Ethernet cable and the connector replaced with an appropriate Ethernet connector for coupling into an Ethernet port on a LAN card on a computing device.

FIG. 4 illustrates further details of access point 102, including a bind button 142 that is optionally included on the access point 102 that can be activated by a person who is authorized to determine whether another computing device joins the secure wireless network. Instead of using bind button 124 on wireless network interface device 120, or bind button 142 on access point 102, a software bind control in a graphic user interface can be displayed to the user of the associated computing device that is coupled to the access point or to the wireless network interface device. The software bind control can be selectively activated by a user to implement joining a computing device to a temporary secure wireless network.

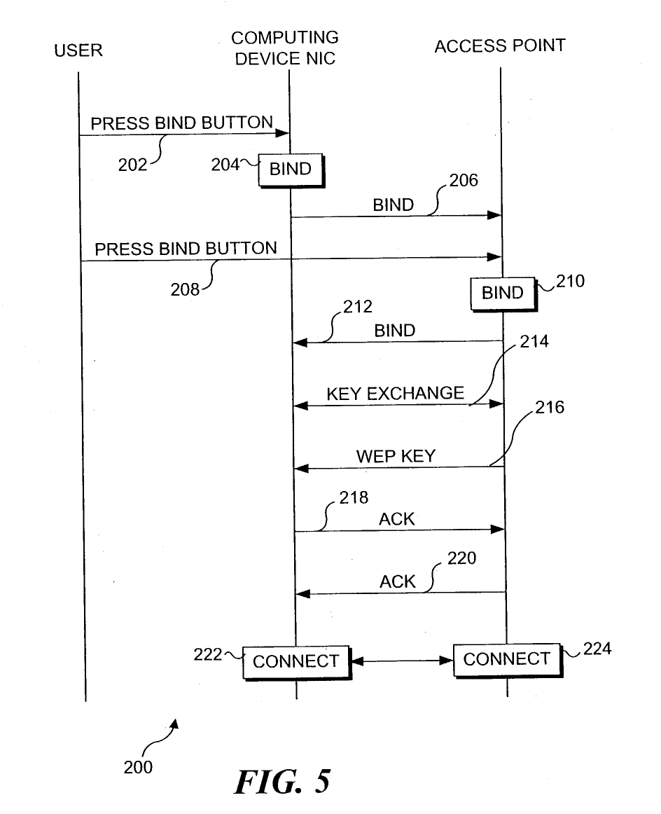

Steps 200, which are shown in FIG. 5, generally explain how the present invention is used for joining a computing device to a secure wireless network when the process is initiated by a user, who either presses bind button 124 on wireless network interface device 120 of the computing device to be joined to the secure wireless network or activates a software bind control on a graphic user interface to the wireless network interface device. Selecting a bind option in a step 202 causes a step 204 to be implemented on the computing device wireless NIC. As used herein, the term “NIC” is intended to encompass an internal wireless network interface card of the type that plugs into the bus of a conventional PC, a network interface device that is coupled to the computing device through a USB, Ethernet, or other communication port, and a PCMCIA card 114, which provides the wireless interface for a computing device, such as PCMCIA card 114 in FIG. 2.

In response to the bind control being actuated on the computing device that the user wants to join to the secure wireless network in step 204, a bind signal 206 is transmitted to the access point. The person authorized to determine whether the computing device will be permitted to join the secure wireless network can selectively then press the bind button in a step 208. Again, the bind button can either be a hardware bind button 142, or a software bind control. If the person selectively activates the bind control, a bind step 210 is carried out on the access point. Accordingly, the access point transmits a bind signal 212 back to the computing device that is to join the secure wireless network. Next, a step 214 carries out a key exchange to initiate a secure transmission from the access point to the computing device. The key exchange produces an encryption key enabling the access point to transmit an encrypted message that conveys the SSID and WEP key to the computing device in a step 216. In a step 218, the computing device decrypts the SSID and WEP key and acknowledges receipt of these parameters. Finally, the access point transmits an acknowledgement 220 to the computing device. The computing device then uses the SSID and WEP key that it received from the access point to make a connection to the wireless network in a step 222. The access point responds to the transmission of the SSID and WEP that were sent to the computing device and accepts the connection in a step 224 so that the computing device is now joined to the secure wireless network. The computing device is now coupled in communication with the access point and with other computing devices comprising the secure wireless network and has access to any other network connection provided on the secure wireless network. Alternatively, a WPA key or other type of network credentials can be employed in the present invention to automate joining a secure wireless network that uses that form of credentials.

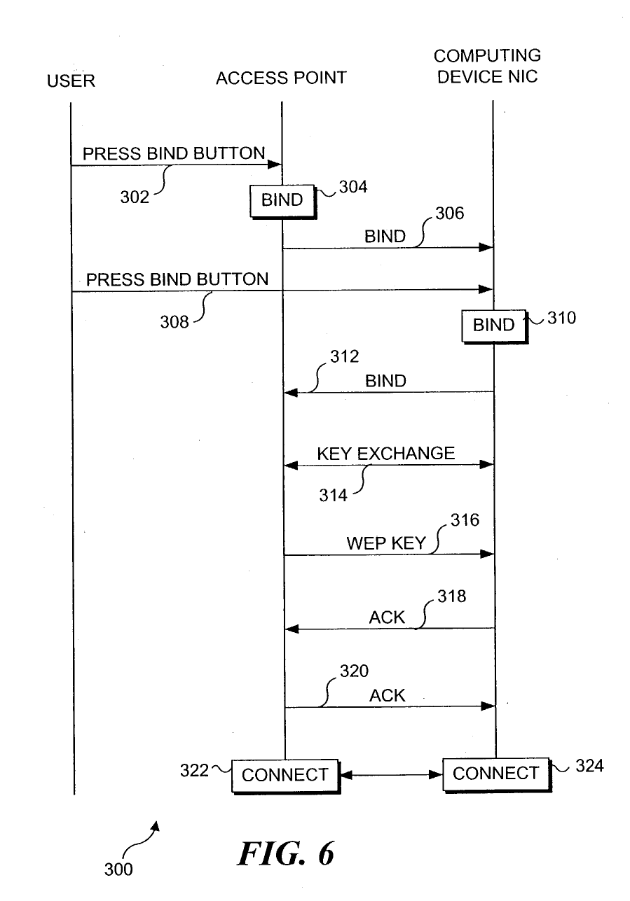

Steps 300, which are illustrated in FIG. 6, generally explain how a computing device is joined to a secure wireless network when the process is initiated at the access point. In a step 302, a person authorized to determine if the computing device will join the secure network presses the bind button or selects the bind control in a graphic user interface for the access point. In response, a bind step 304 causes the access point to transmit a bind signal 306 to the computing device. Next, a user of the computing device (which may be the same person that pressed the bind button in step 302) presses a bind button in step 308 or selects a bind control in a graphic user interface for the computing device, causing its wireless NIC to initiate a bind step 310. In response, the computing device wireless NIC transmits a bind signal 312 to the access point. The access point and computing device NIC carry out a key exchange in a step 314, to provide an encryption key for use in encrypting the network credential, such as the SSID and WEP key, in an encrypted message transmitted from the access point to the computing device in a step 316. The computing device then decrypts the message to recover the network credentials and acknowledges receipt of the network credentials at a step 318. In response, the access point sends an acknowledgement back to the computing device at a step 320. Finally, the computing device uses the network credentials to join the secure wireless network in a step 324, and the connection and join is accepted by the access point in a step 322.

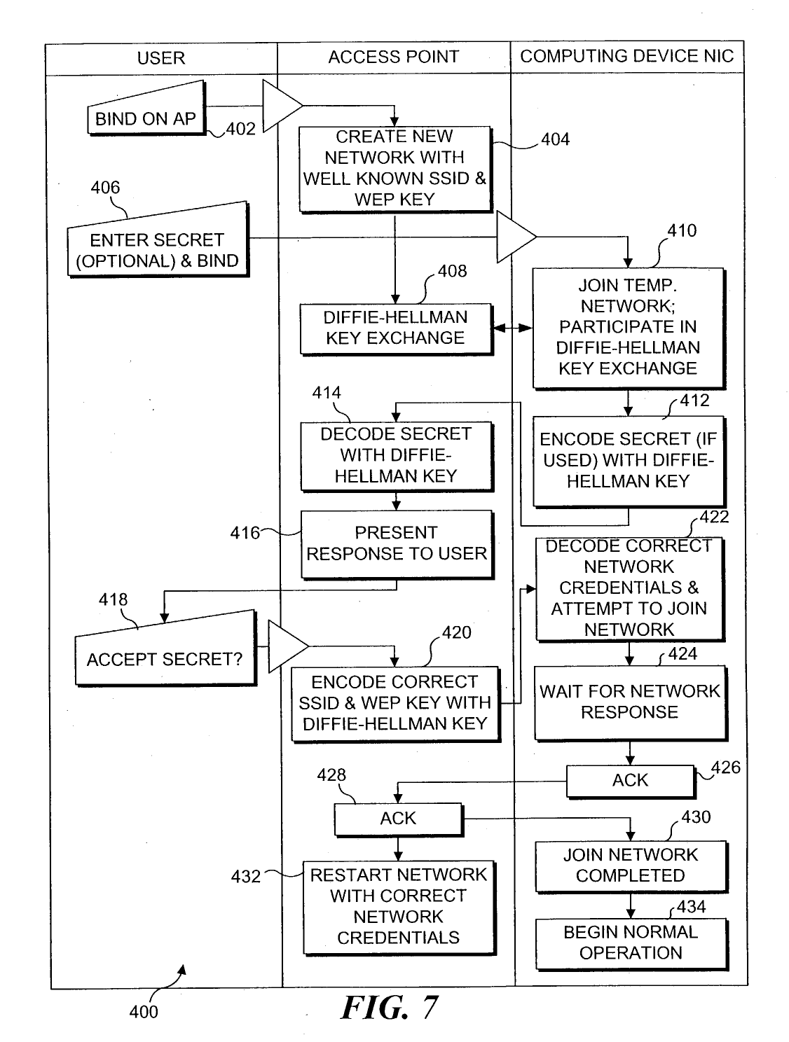

While FIGS. 5 and 6 generally illustrate steps for joining the computing device to the secure wireless network in accord with the present invention, a block diagram 400 in FIG. 7 shows details of the process. If the person authorized to add a computing device to the secure wireless network initiates the procedure, block 402 provides for a bind step to be carried out, initiated either by pressing the hardware bind button or by selecting the bind control provided in a graphic user interface for the access point. A new temporary alternate network used only while joining the computing device to the secure wireless network is created in a step 404; this alternate network is used only by the access device and the computing device when joining the computing device to the normal secure network. During this step, a well known SSID and WEP key (or other well known credentials) are employed to create the alternate network between the access point and the computing device. Both the access point and the of the computing device NIC must be aware of the well known SSID and WEP employed in the temporary alternate network between the access point and the computing device.

Alternatively, the user of the computing device can initiate the bind step. Optionally, in a step 406, the user can also enter a secret, e.g., a phrase or a word known both to the user and to the person authorized to add the computing device to the secure wireless network. The secret is entered on the computing device using a conventional keyboard or other input device. If the user of the computing device initiates the process, the person authorized to determine whether to join the computing device to the secure network would then follow with step 402. In either case, after creating the new temporary alternate network, a step 408 provides that the access point and the computing device NIC carry out a Diffie-Hellman key exchange. The Diffie-Hellman key exchange is preferred for determining an encryption key that will be used on the alternate network created in step 404 to enable the access point to produce an encrypted message for conveying the SSID and WEP key to the computing device. The computing device then decrypts the message with the key, to recover the network credentials, such as the SSID and WBP key. However, it is also contemplated that a private/public key set can also be used for the encryption/decryption steps.

In a step 410, the computing device joins the temporary alternate network that was created by the access point in step 404. In addition, the computing device participates in the Diffie-Hellman key exchange with the access point. Next, in a step 412, the computing device encrypts the secret (if it was used) using the Diffie-Hellman key that was developed. The purpose of providing a secret that is encrypted by the computing device with the Diffie-Hellman key is to detect a third party that might be intercepting communications between the computing device and prevent the third party from being joined to the secure wireless network without authorization. Since only the user of the computing device and the person authorized to join the computing device to the secure wireless network should know the secret, a third party computing device will not be able to successfully represent itself as the computing device being authorized to join the secure network.

If the secret is used, the secret is decrypted at the access point using the Diffie-Hellman key in a step 414. The decrypted secret is then presented in a step 416 to the person authorized to enable the computing device to join the network. In a step 418, that person determines if the secret that was decrypted is correct. If the secret is correct, in a step 420, the access point encrypts the correct network credentials (e.g., the SSID and WEP key) for the secure wireless network using the Diffie-Hellman key. The encrypted message that contains the network credentials is then conveyed over the temporary alternate network to the computing device NIC, which decrypts the message to recover the correct network credentials. The network credentials are used by the computing device NIC to join the secure wireless network, in a step 422. A step 424 provides that the computing device NIC waits for the response from the secure wireless network. The computing device transmits an acknowledgement to the access point at a step 426, and in response, the access point transmits an acknowledgement back to the computing device in a step 428. In a step 430, the computing device is joined to the secure wireless network. Accordingly, the access point responds to the acknowledgement from step 428, and in a step 432 restarts the secure wireless network with the correct network credentials (e.g., SSID and WEP key, or the WPA key) that were previously provided to the computing device. Thereafter, the computing device begins normal operation in a step 434, being now able to communicate with each of the other computing devices that are on the secure wireless network, and if available, to access the broadband connection.

If the person authorized to join the computing device to the secure wireless network decides to reject the attempt, the procedure can be interrupted by not binding the computing device into the temporary alternate network in step 404. Alternatively, in step 418, the person can elect not to accept the secret or not to transmit the encrypted network credentials (e.g., the SSID and WEP key or the WPA key) that are required by the computing device to join the secure wireless network in step 420. Use of the secret prevents a third party who is not truly authorized from perpetrating a ruse to join the secure wireless network. Alternatively, the computing device can transmit a verified digital signature to the access point, using a verification certificate provided by a trusted third party, e.g., by VeriSign, Inc.

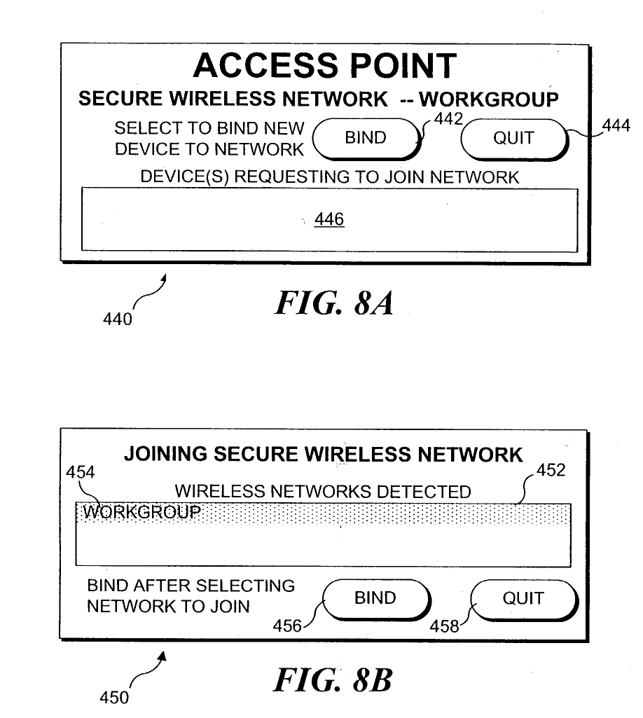

FIG. 8A illustrates a graphic user interface dialog 440 that includes a bind control 442 and a quit control 444. The graphic user interface dialog shown in FIG. 8A is provided on a PC or other computing device that is administering the access point. It should be understood that graphic user interface dialog 440 is simply exemplary and many different forms and formats can alternatively be employed to enable the user to bind a computing device to a secure wireless network. If a user of the computing device has initiated joining the computing device to the secure wireless network, a list box 446 will show the computing device. In the event that a plurality of such devices have pending requests to join the secure wireless network, the user administering the access point can select one of the computing devices included in the lists box 446 before selectively activating bind control 442.

FIG. 8B illustrates an exemplary user interface dialog 450 that is displayed to a user of a computing device to facilitate joining a secure wireless network. The NIC of the computing device will detect and identify any accessible wireless networks that are operating in a list box 452. An exemplary secure wireless network 454 named “Workgroup” is illustrated. The user can then either initiate the join procedure by selecting a bind control 456, or can respond to the access point transmitting a bind signal to the computing device by activating bind control 456. Also provided is a Quit control 458. Since a corporate environment may have a plurality of secure wireless networks, the user of the computing device can select a specific one of the secure wireless networks included in list box 452, before activating the bind control.

The authorization provided for a computing device to be joined to a secure network can be temporary. The network key (e.g., the WEP key or the WPA key) for a secure network can periodically be changed. Thus, the next time that the computing device is brought into range of the secure wireless network, it may again need to be joined to the network. Thus, the permission to join the network can be granted for only a predefined or limited time (i.e., until the network key for the network is changed).

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for joining a computing device to a secure network, comprising the steps of:
(a) enabling a user to initiate joining of the computing device to the secure network;
(b) in response to an initiation for the computing device to join the secure network, creating an alternate communication link between the computing device and an access point of the secure network;
(c) transmitting credentials necessary to join the secure network to the computing device; and
(d) using the credentials received by the computing device to join the computing device to the secure network.

2. The method of claim 1, further comprising the steps of:
(a) encrypting the credentials required for communication over the secure network, creating an encrypted message;
(b) transmitting the encrypted message to the computing device over the alternate network; and
(c) decrypting the encrypted message at the computing device, to recover the credentials.

3. The method of claim 2, further comprising the step of determining an encryption key for use in encrypting the credentials to create the encrypted message, and for decrypting the encrypted message to recover the credentials.

4. The method of claim 2, wherein a public and private key combination are used for encrypting and decrypting the credentials.

5. The method of claim 2, wherein a Diffie-Hellman key exchange is used for encrypting and decrypting the credentials.

6. The method of claim 1, further comprising the steps of:
(a) enabling the user to enter a secret on the computing device, said secret being known to a person at the access point, who is authorized to selectively enable the computing device to join the secure network;
(b) encrypting the secret at the computing device, producing an encrypted secret message;
(c) transmitting the encrypted secret message to the access point; and
(d) decrypting the encrypted secret message to recover the secret at the access point, to enable the person to determine that the secret thus recovered is correct and to thereby prevent a third party intermediary who may be intercepting communications over the alternate network from being improperly authorized to communicate over the secure network.

7. The method of claim 1, further comprising the step of enabling the user to initiate joining the secure network through the computing device.

8. The method of claim 1, further comprising the step of enabling the user to initiate joining the secure network through the access point.

9. A memory media having machine instructions stored thereon for carrying out the steps of claim 1.

10. A method for selectively automatically enabling a computing device to join a secure network, comprising the steps of:
(a) enabling activation of a bind option on the computing device and on an access point used on the secure network;
(b) in response to the bind option being activated, automatically producing a secure encrypted communication link between the computing device and the access point;
(c) selectively transmitting a secure encrypted message from the access point to the computer device after authorization is granted for the computing device to join the secure network, said encrypted message conveying credentials that are required by the computing device for joining the secure network;
(d) decrypting the encrypted message to recover the credentials, at the computing device; and
(e) using the credentials at the computing device to join the computing device to the secure network.

11. The method of claim 10, wherein the step of automatically producing the encrypted wireless network comprises the step of producing an encryption key for use in communicating over the encrypted communication link.

12. The method of claim 10, further comprising the steps of:
(a) enabling entry of a secret on the computing device, said secret being known by a person enabled to selectively authorize the computing device to join the secure network;
(b) encrypting the secret in a secure encrypted message that is transmitted to the access point; and
(c) decrypting the secure encrypted message at the access point to recover the secret, enabling said person to determine if the secret that is known was actually recovered, and if not, preventing a third party intermediary who may have intercepted the encrypted message from being improperly authorized to communicate over the secure network.

13. The method of claim 10, wherein the step of automatically producing the encrypted communication link comprises the step of employing a Diffie-Heilman key exchange.

14. The method of claim 10, wherein the step of automatically producing the encrypted communication link comprises the step of employing a private/public key for encrypting and decrypting communications.

15. The method of claim 10, further comprising the step of interrupting other communications over the secure network while joining the computing device to the secure network.

16. The method of claim 10, wherein the step of enabling activation of the bind option comprises the step of displaying a graphic user interface option to bind the computing device to the secure network.

17. The method of claim 10, wherein the credentials comprise a Service Set Identifier (SSID) and a Wired Equivalent Privacy (WEP) key.

18. The method of claim 10, wherein the credentials comprise a Wireless Protected Access (WPA) key.

19. A memory medium on which are stored machine instructions for carrying out the steps of claim 10.

20. A system for joining a secure network, comprising:
(a) a memory in which a plurality of machine instructions are stored;
(b) a network communication interface; and
(c) a processor coupled to the memory and the network communication interface, said processor executing the machine instructions, which cause the processor to carry out a plurality of functions, including:
(i) enabling a user to initiate joining of the computing device to the secure network;
(ii) participating in creating an alternate communication link between the computing device and an access point of the secure network;
(iii) receiving credentials required for joining the secure network over the alternate communication link, from the access point; and
(iv) using the credentials on the computing device to join the computing device to the secure network.

21. The system of claim 20, wherein the machine instructions further cause the processor to decrypt an encrypted message used to convey the credentials to the computing device from the access point in a secure encrypted message.

22. The system of claim 20, wherein the network interface comprises a wireless network communication device.

23. The system of claim 20, wherein the machine instructions further cause the processor to enable a user to enter a secret that is included in a secure encrypted transmission to the access point over the alternate communication link, said secret being known to a person authorized to permit the computing device to join the secure network.

24. The system of claim 20, wherein the machine instructions cause the processor to enable the alternate communication link to be established with the access point using a Diffie-Hellman key exchange.

25. The system of claim 20, wherein the machine instructions cause the processor to enable the alternate communication link to be established with the access point using a private/public key.

26. The system of claim 20, further comprising a display, wherein said machine instructions further cause the processor to display a bind option in a user interface on the display, said bind option being selectively activated to initiate joining the secure network.

27. The system of claim 20, wherein the credentials comprise a Service Set Identifier (SSID), and a Wired Equivalent Privacy (WEP) key.

28. The system of claim 20, wherein the credentials comprise a Wireless Protected Access (WPA) key.

29. A system for facilitating joining a computing device to a secure network, comprising:
(a) a memory in which a plurality of machine instructions are stored;
(b) a network communication interface; and
(c) a processor coupled to the memory and the network communication interface, said processor executing the machine instructions, which cause the processor to carry out a plurality of functions, including:
(i) enabling a user to initiale joining of the computing device to the secure network;
(ii) participating in creating an alternate communication link with the computing device;
(iii) using the alternate communication link, transmitting credentials required for communication over the secure network, to the computing device; and
(iv) joining the computing device to the secure network in response to the computing device requesting to be joined using credentials.

30. The system of claim 29, wherein the processor, network communication interface, and memory comprise an access point on the secure network.

31. The system of claim 29, wherein the machine instructions further cause the processor to encrypt the credentials, to produce an encrypted message that is transmitted to the computing device over the alternate communications link.

32. The system of claim 29, wherein the machine instructions further cause the processor to:
(a) receive an encrypted message that conveys a secret, from the computing device;
(b) decrypt the encrypted message to recover the secret; and
(c) compare the secret to a known secret, to selectively determine that the credentials are to be transmitted to the computing device if the secret and the known secret match, but to detect an unauthorized third party attempting to join the secure network if the secret and known secret do not match.

33. The system of claim 29, wherein the machine instructions cause the processor to enable the alternate communication link to be established with the computing device using a Diffie-Hellman key exchange.

34. The system of claim 24, wherein the machine instructions cause the processor to enable the alternate communication link to be established with the computing device using a private/public key.

35. The system of claim 29, further comprising a display, wherein said machine instructions further cause the processor to display a bind option in a user interface on the display, said bind option being selectively activated to initiate joining the computing device to the secure network.

36. The system of claim 29, wherein the credentials comprise a Service Set Identifier (SSID), and a Wired Equivalent Privacy (WEP) key.

37. The system of claim 29, wherein the credentials comprise a Wireless Protected Access (WPA) key.
